(19) United States
(12) Patent Application Publication
(10) Pub. No.: US 2008/0262955 A1
(43) Pub. Date: Oct. 23, 2008

(54) Apparatus to Facilitate Multi-Dimensional Representation of Financial Data

(76) Inventor: Lisa M. Erdmier, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 12/115,002

(22) Filed: May 5, 2008

Related U.S. Application Data
(63) Continuation-in-part of application No. 10/122,990, filed on Apr. 15, 2002, now abandoned.
(60) Provisional application No. 60/284,124, filed on Apr. 16, 2001.

(51) Int. Cl. G06Q 40/00

(52) U.S. Cl. 705/35

(57) ABSTRACT

Trading information for securities is received and processed. This processing permits the determination of a close price for a current trading period, a close price for a previous trading period, a last trading price for the current trading period, a plurality of trading prices and corresponding trading volumes during the current trading period, and a plurality of trading prices and corresponding trading volumes during the previous trading period. This processed information is then output as a chart. By one approach, a relative minority of these items of processed information are additionally highlighted with a unique visual symbol.

### RELATED APPLICATION(S)

This application claims the benefit of U.S. Provisional application No. 60/284,124, filed Apr. 16, 2001, which is incorporated by reference in its entirety herein.

This application is a continuation-in-part application of co-pending and co-owned U.S. patent application Ser. No. 10/122,990, entitled MULTI-DIMENSIONAL REPRESENTATION OF FINANCIAL DATA and filed Apr. 15, 2002, which is incorporated by reference in its entirety herein.

### TECHNICAL FIELD

This invention relates generally to the processing and display of securities trading information.

### BACKGROUND

As the result of the increasing importance of the role which commercial securities as a component for asset management and as a major indicator of the health of the general economy, there has also been a steadily growing public awareness and interest in financial presentations. Most daily newspapers now report a list of selected stocks with their respective daily trading volumes, the trading ranges, and the closing prices. Some papers and other media (e.g., TV) also provide such information in graphical form, typically, a time-line graph showing the prices at selected time intervals (e.g., hourly, every 10 minutes, etc.).

To a large extent, there exists an important relationship between the market behavior of a security and its trading volume. The price of a security, like that of any other goods or services, is subject to the law of supply a demand. While there are many determinants which influence the price of a stock, the most important one is undoubtedly the perception of the prospect of future earnings. If there is a large number of traders who believe that such prospects warrant a certain price, the trading volume will be high, and vice versa. In other words, a good display of the history of a security should include not only the prices, but also the volumes at such prices. Indeed, whether viewed academically from the acclaimed efficient market theory, or technically from the momentum rule, the trading volume at different prices would be a useful indicator as to the movement of a market.

Although several methods exist to display the prices, volumes, and other information relating to the trading history of a security, some methods are useful only for persons who are highly trained in matters of securities transactions. Alternatively, some displays provide only very limited information. One example of this second type of displays is a display of only the daily trading ranges and the closing prices. A second example is a time-line graph of the price of a security. Displays of this type, though of interest, would not be able to provide much important information and offer only a limited amount of pricing information. In volatile markets such as we are experiencing in recent years, a variation of several percentage points (or much more) between the daily highs and lows for a given security has become more a general rule rather than a special situation. Without more specifics as to the volume in which a security is traded at certain price, the financial information is incomplete or are useful only for a person well trained in the intricacies of securities transactions.

For today's markets, transparency and quickness are of importance not only to a professional trader, but also to the general investing public. This latter group, much larger in number than trained securities traders, would benefit from simple graphical displays of the history of both the prices and the trading volumes at such prices, and by simple graphical displays of historical boundary values such as the high, low, open, and close prices of a security during a period of interest to the specific investor.

### BRIEF DESCRIPTION OF THE DRAWINGS

The above needs are at least partially met through provision of the apparatus to facilitate multi-dimensional representation of financial data described in the following detailed description, particularly when studied in conjunction with the drawings, wherein:

FIG. 1 comprises a flow diagram as configured in accordance with various embodiments of the invention;

FIG. 2 comprises an exemplary view of a chart as displayed in accordance with various embodiments of the invention;

FIG. 3 comprises an exemplary view of a chart as displayed in accordance with various embodiments of the invention;

FIG. 4 comprises an exemplary view of a chart as displayed in accordance with various embodiments of the invention;

FIG. 5 comprises an exemplary view of a chart as displayed in accordance with various embodiments of the invention;

FIG. 6 comprises an exemplary view of a chart as displayed in accordance with various embodiments of the invention;

FIG. 7 comprises an exemplary view of a chart as displayed in accordance with various embodiments of the invention;

FIG. 8 comprises an exemplary view of a chart as displayed in accordance with various embodiments of the invention;

FIG. 9 comprises an exemplary view of a chart as displayed in accordance with various embodiments of the invention;

FIG. 10 comprises an exemplary view of a chart as displayed in accordance with various embodiments of the invention; and

FIG. 11 comprises a block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, trading information for securities that are traded in a market is received and processed. This processing permits the determination, for a given one (and often each of) these securities, of a close price for a current trading period, a close price for a previous trading period, a last trading price for the current trading period, a plurality of trading prices and corresponding trading volumes during the current trading period, and a plurality of trading prices and corresponding trading volumes during the previous trading period. This processed information is then output as a chart.

By one approach, this chart has a first area that represents the previous trading period and a second area that is positioned adjacent the first area and that represents the current trading period. A vertical axis can separate the first area from the second area and can identify trading prices for both the current trading period and the previous trading period. A plurality of horizontal bars in the first area can each have a position with respect to the vertical axis that serves to indicate a particular trading price and a length that serves to indicate the corresponding trading volume at that trading price. A similar plurality of horizontal bars in the second area can serve a similar purpose for current trading period information.

By one approach, certain, but not all, of the items of processed information are differently highlighted with a unique visual symbol. By one approach, this can comprise having only a relative minority (such as, less than 50% of all the items, less than 25% of all the items, less than 5% of all the items, less than 1% of all the items, and so forth) of these items of processed information be additionally highlighted with a unique visual symbol. Examples in this regard include, but are not limited to, a color that is highly contrastive to other colors that comprise the chart, an animated element that contrasts with static elements as otherwise comprise the chart, and/or any other contrastive graphics element that can serve such a purpose. So configured, particularly noteworthy information, or information that tends to be of common, initial, and immediate interest can be readily identified and gleaned by an observer in a very short amount of time.

So configured, these teachings provide, at a glance, simple and yet comprehensive snapshots of the price-volume actions of a security from one time frame (such as one trading period) to a second time frame (such as another trading period) without the need for mechanically going through pages of data and making comparative evaluations either mentally or assisted by other means. Those skilled in the art will further recognize and appreciate that these teachings are very flexible, readily scaled, and easily leveraged to accommodate a wide variety of application settings. For example, if desired, a simplified and yet informative display could be made through the elimination of daily fluctuations and the use of boundary lines for the high and low prices for a time period of interest. Alternatively, market dynamics based on addition relevant data such the high, low, close, last trade, and the trading volumes at all trading prices could also be summarized on a single axis in a comparative form in a single a display that is easy to understand.

Those skilled in the art will further appreciate that these teachings can be dynamically applied, for example, to reflect instantaneous changes in price and volume, or statically applied, for example, at the conclusion of a trading period (such as only once a day). These teachings will serve, if desired, to depict the price in one dimension and the trading volume in a second dimension in the same sub-unit of a second time interval (for example, one hour, one day, ten-minutes, and so forth), and then to depict these sub-units sequentially by time (and possibly, if desired, adjacent to one another).

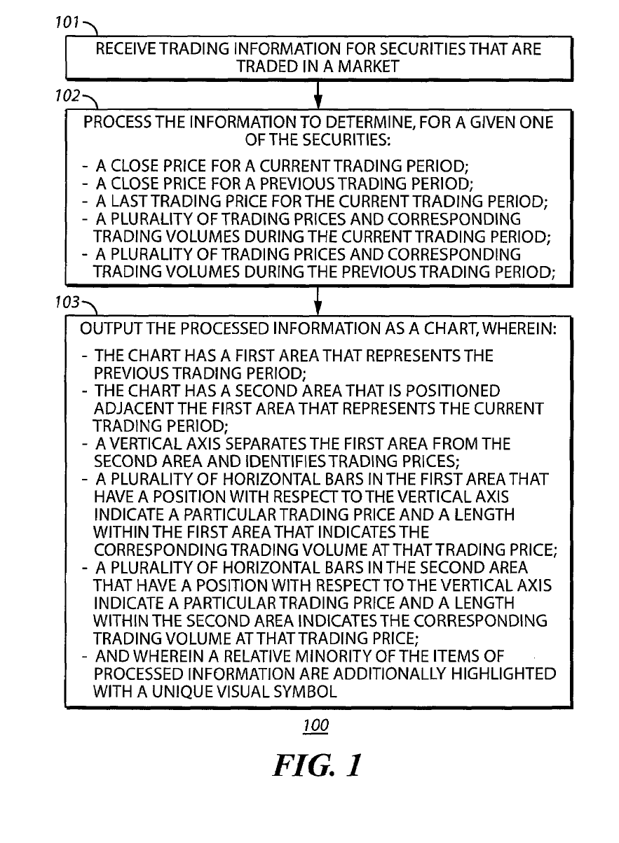

These and other benefits may become clearer upon making a thorough review and study of the following detailed description. Referring now to the drawings, and in particular to FIG. 1, an illustrative process that is compatible with many of these teachings will now be presented.

This process 100 provides for receiving 101 trading information for securities that are traded in a given market (for example, a particular stock market or the like). This information can be received in batch format for some given period and/or can comprise real-time or near-real-time incremental updates that are received on an on-going basis (for example, during a current trading period). The information itself can comprise, for example, various kinds of pricing information, sales volume information, and so forth.

This process 100 then provides for processing 102 this information to determine, for a given one of the securities, a variety of specific items of information. Examples in this regard can include, but are not necessarily limited to

a close price for a current trading period;

a close price for a previous trading period;

a last trading price for the current trading period;

a plurality of trading prices and corresponding trading volumes during the current trading period (which might comprise, for example, all of the representative trading volumes for the current trading period and which therefore might also represent the high and low boundaries for this particular trading period); and/or

a plurality of trading prices and corresponding trading volumes during the previous trading period (which might again comprise, if desired, all of the representative trading volumes for the previous trading period and which therefore might also represent the high and low boundaries for that particular trading period).

Those skilled in the art will recognize that the previous trading period can comprise essentially any window of time as might be of interest. By one approach, this previous trading period can comprise a most recently previous complete trading day. By another approach, this previous trading period can comprise an aggregation of a plurality of previous complete trading days (such as a week of trading activity, a month of trading activity, and so forth). It would also be possible for this previous trading period to comprise only some portion of a complete previous trading period, such as the afternoon portion of a previous trading day. Yet other possibilities exist in these same regards as will be well understood by those skilled in the art. For example, the previous trading period can comprise, if desired, an earlier part of a trading period that also includes the current trading period.

In a somewhat similar manner, the current trading period can comprise a most recently completed trading period, such as a last complete trading day. By another approach, however, this current trading period can comprise a not-yet-completed trading period. By this approach, the current trading period might comprise, for example, as much of the current trading day as has yet been completed (possibly delayed, in some instances, by some amount of time such as fifteen minutes or the like). When the current trading period comprises a not-yet-completed trading period, the aforementioned close price for that period may comprise, for example, a most current price for the current trading period.

This process 100 then provides for outputting 103 this processed information in the form of a chart. A chart is a type of information graphic or graphic organizer that represents tabular numeric data and/or functions. Charts are often used to make it easier to understand large quantities of data and the relationship between different parts of the data. By one approach, and for these present purposes, this chart can be configured such that:

the chart has a first area that represents the previous trading period (wherein, by one approach, this first area is bounded by a highest price and a lowest price for the previous trading period);

the chart has a second area that is positioned adjacent to the first area, wherein the second area represents the current trading period (and wherein, by one approach, this second area is bounded by a highest price and a lowest price for the current trading period);

a vertical axis separates the first area from the second area and identifies trading prices;

a plurality of horizontal bars in the first area have a position with respect to the vertical axis to indicate a particular trading price and a length within the first area that indicates the corresponding trading volume at that trading price;

a plurality of horizontal bars in the second area have a position with respect to the vertical axis to indicate a particular trading price and a length within the second area that indicates the corresponding trading volume at that trading price; and

wherein certain, but not all, of the items of processed information are differently highlighted with a unique visual symbol (where this can comprise, if desired, having only a relative minority of these items of processed information be additionally and differently highlighted with a unique visual symbol).

The form and nature of this unique visual symbol can vary with the needs and/or opportunities as tend to characterize a given application setting. Generally speaking, this unique visual symbol is “unique” in that the visual symbol is limited to use with a given item of processed information. For example, such a visual symbol might be reserved for use with only:

high volume lines around, or surrounding, the closing price for a given period of time;

a defined “value area” for a given time frame (such as the well known 70% value area used by many traders to gauge market momentum);

ratios of interest (such as a ratio of volume lines to average daily volume where, for example, one visual symbol is used for data that is greater in value than this ratio and another visual symbol is used for data that is less in value than this ratio);

displayed data that has a particular predefined relationship with a market number of interest, such as the well known Pivot, Support, and/or Resistance numbers (for example, to display high volume lines surround a Pivot number);

high/low volume areas around time period highs and lows (to thereby facilitate identifying when the highs/lows represent rejection areas or value areas); and so forth.

The unique visual symbol itself is one that contrasts visually with other display elements of the chart; that is, one that comprises a contrastive graphics element (such as bold font, italics font, underlined font, thickened lines, and so forth). This can also comprise, for example, using a color that is highly contrastive to other colors that comprise the chart. To illustrate, this might comprise using the colors red and green as unique visual symbols when the bulk of the chart appears as black on white. As another example, this can comprise using an animated element that contrasts with static elements as comprise the chart. To illustrate, this might comprise causing the data of interest to blink on and off, or to change from one color to another.

This process 100 will readily accommodate a wide range of flexibility with respect to the specific ways in which these particular elements are ordered, manipulated, and arranged. A number of representative charts will now be presented to illustrate this point.

1. A Snapshot View for Two Consecutive Trading Periods.

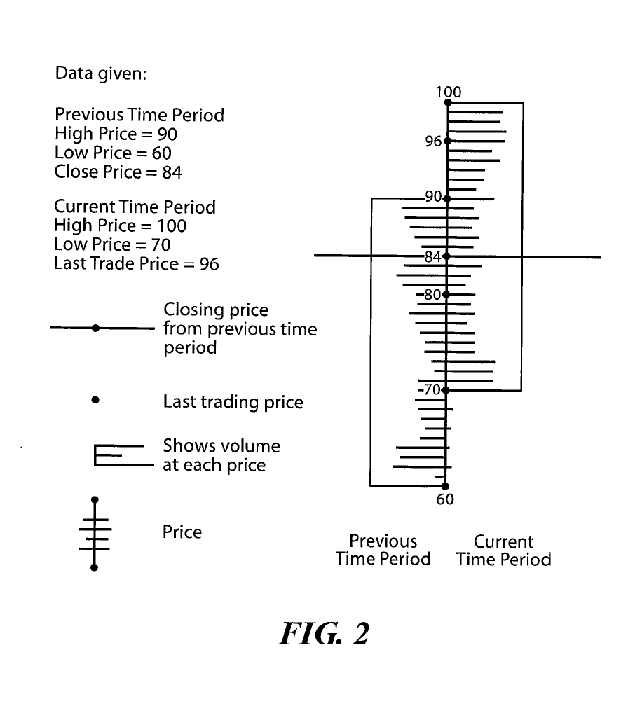

A resultant chart for period-to-period presentation is illustrated in FIG. 2. The objective of this presentation is to give a simplified snapshot-view of the trading pattern of two consecutive periods and to provide information that is easier to visualize than a bar chart. Specifically, this method of presentation shows the high/low prices of the previous period (such as a previous trading day) as compared to the high/low prices of the current period (such as the current trading day). The close from the previous day is shown in a horizontal line through both periods. The volume is given at all trading prices, and the last trade (close) price is also shown. In this illustrative example, the relevant data are as follows:

| | | | Last Trade or |
|---|---|---|---|
| Period | High Price | Low Price | Close Price |
| Previous | 90 | 60 | 84 |
| Current | 100 | 70 | 96 |

The vertical axis shows the price, the horizontal bars show the volume, and the two consecutive time periods (previous and current) are drawn next to each other in the aforementioned areas in the form here of closed boxes having their upper and lower boundaries show the high/low prices for each period. (Those skilled in the art will appreciate that these closed boxes are used for illustrative purposes and that it would not be necessary to employ closed boxes. It would be possible, for example, to simply use the high and low values to establish the corresponding boundaries.) By depicting a direct price comparison, this gives the numbers greater value.

2. Current Period Versus Average of a Longer Prior Period.

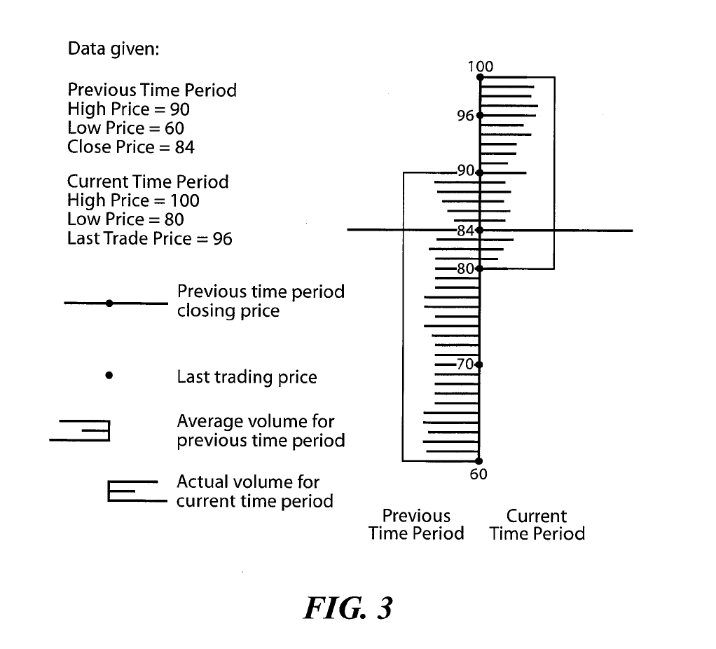

FIG. 3 is similar to FIG. 2, but is included to underscore the flexibility of these teachings. In particular, the two time periods need not be of the same length because it may be useful sometimes to have a quick view of a longer prior period, and furthermore, it provides a measure of the weight (volume traded) of the various prices and thereby enables one to determine the relative strength or weakness of a given price of interest over time. Specifically, this chart shows the information for the previous week as compared to today. It may be useful, at least in some application settings, to normalize the volume for the previous week by using an average daily volume that can be easily determined by summing the daily volumes and then dividing the total by the number of trading days. In this particular illustrative example, the relevant data are as follows:

| | | | Last Trade or |
|---|---|---|---|
| Period | High Price | Low Price | Close Price |
| Previous | 90 | 60 | 84 |
| Current | 100 | 80 | 96 |

3. Continuous High/Low Comparison.

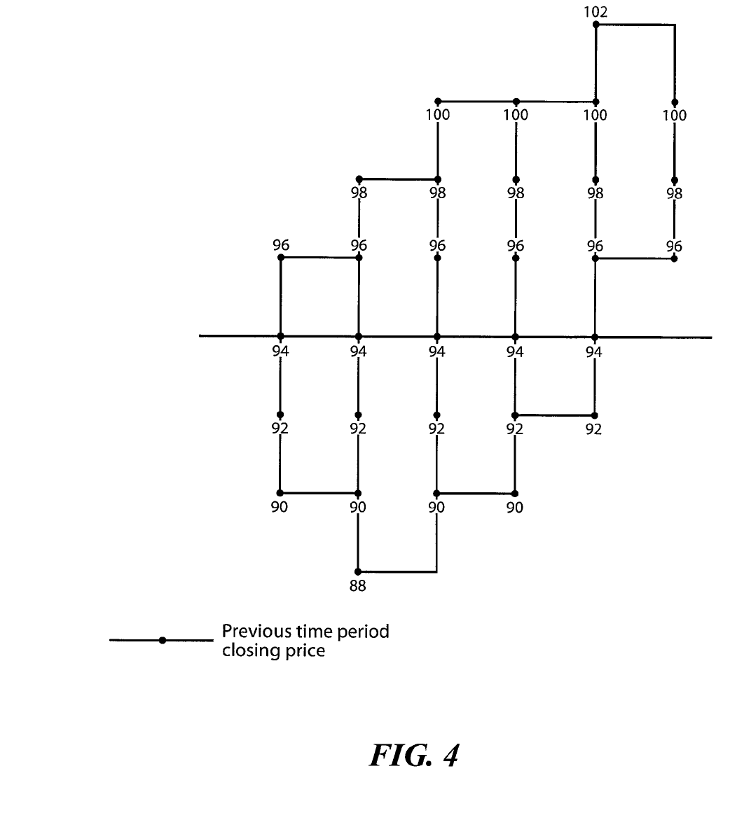

FIG. 4 presents a chart useful for a continuous high/low price comparison, the volume for each price, and the last trade for both periods. If this chart is used for an inter-day comparison, then the close of the previous day, but the last trade of the current period, should be used. In this particular illustrative example, the relevant data are as follows:

| | | | Last Trade or |
|---|---|---|---|
| Period | High Price | Low Price | Close Price |
| Previous | 90 | 60 | 84 |
| Current | 100 | 70 | 94 |

4. High-Volume Areas Emphasized.

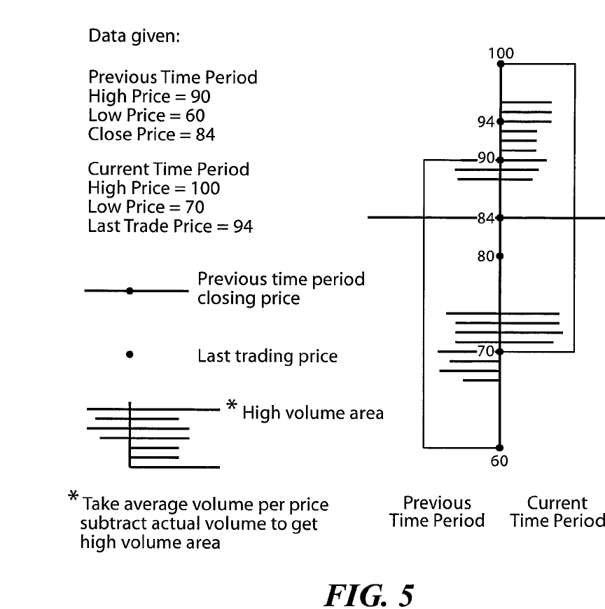

The purpose of FIG. 5 is to emphasize the high volume areas as follows:

Volume shown=Average volume−Actual volume

Otherwise, the same general procedure applied to render the chart depicted in FIG. 2 is again used. In particular, the boundaries are drawn to show the high/low prices and the close of the previous day is also shown. Also, as shown in FIG. 3, the time element can be varied and need not be of the same length of time.

5. Open to Close.

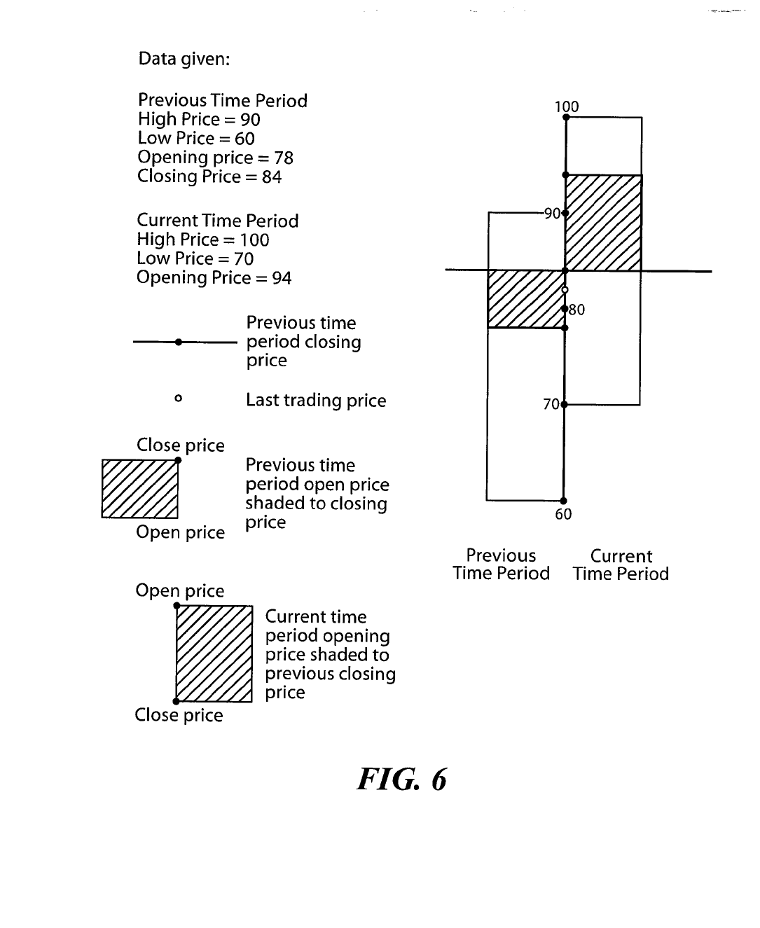

The chart presented in FIG. 6 shows the opening and prices of both the current and the previous periods together with the closing price of the previous period. In this particular illustrative example, the relevant data are as follows:

| | | | | Last Trade or |
|---|---|---|---|---|
| Period | High Price | Low Price | Period | Close Price |
| Previous | 90 | 60 | 78 | 84 |
| Current | 100 | 70 | — | 94 |

6. Volume for Short-Time Periods.

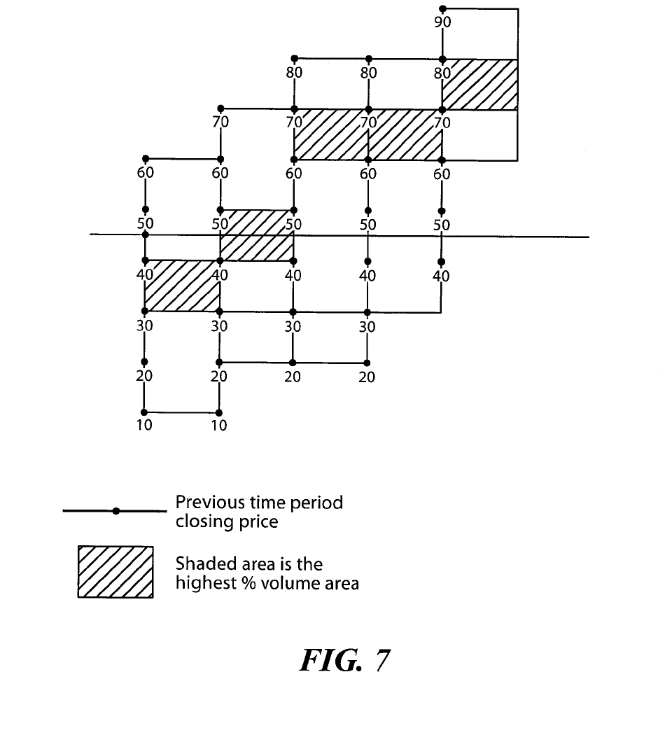

FIG. 7 is a presentation of a chart that incorporates the concepts used in both FIG. 4 and FIG. 6 by shading the area with the highest volume. As in previous figures, the closing prices for the previous period are shown as indicated by the legends therein.

7. Continuous Price Depictions.

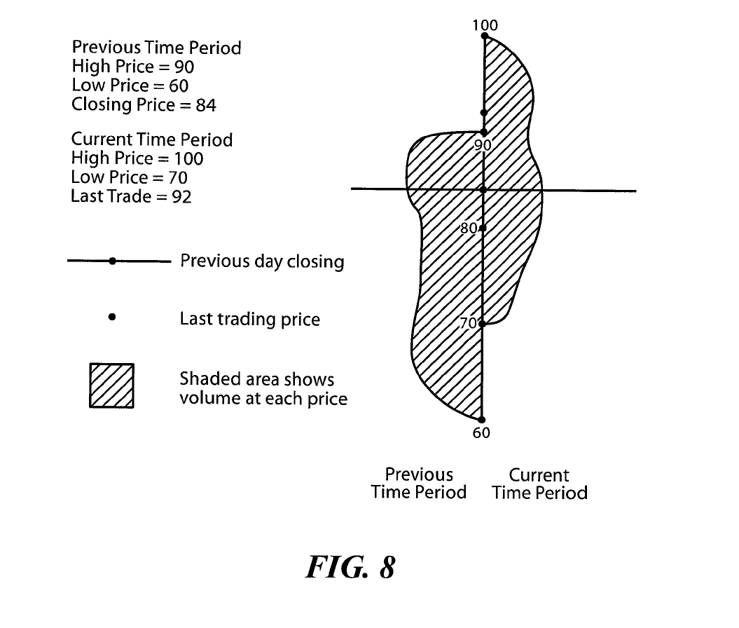

FIG. 8 is an illustration as to how this process can support presenting the data in the entire price range by using shaded areas to shown the trading volumes at each price. This may become more and more important in view of the fact prices on the New York Stock Exchange have now been converted into the decimal system. In this particular illustrative example, the relevant data are as follows:

| | | | Last Trade or |
|---|---|---|---|
| Period | High Price | Low Price | Close Price |
| Previous | 90.00 | 60.00 | 84.00 |
| Current | 100.00 | 70.00 | 94.00 |

8. Percent Change of Prices.

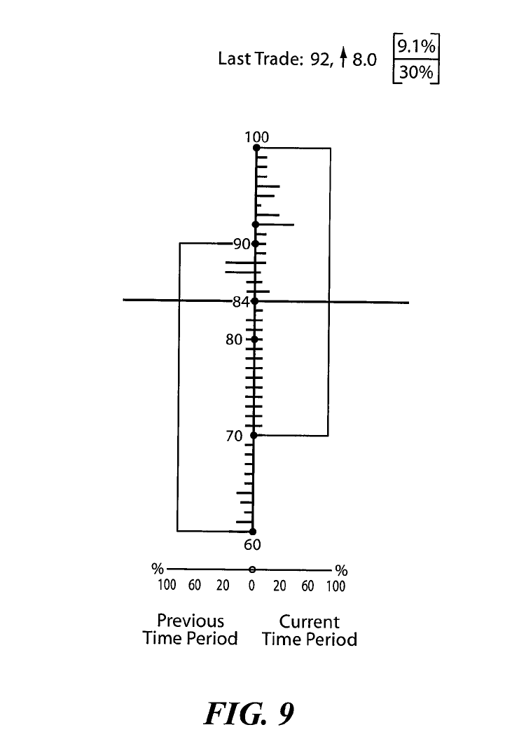

FIG. 9 is similar to FIG. 2, but provides additional information as to the percentage change in price from the closing price of the previous trading period as well as the percent of volume traded at specific prices for two different securities (for example, those of the common stocks of Hewlett Packard and IBM).

9. Inter-Entity Comparisons.

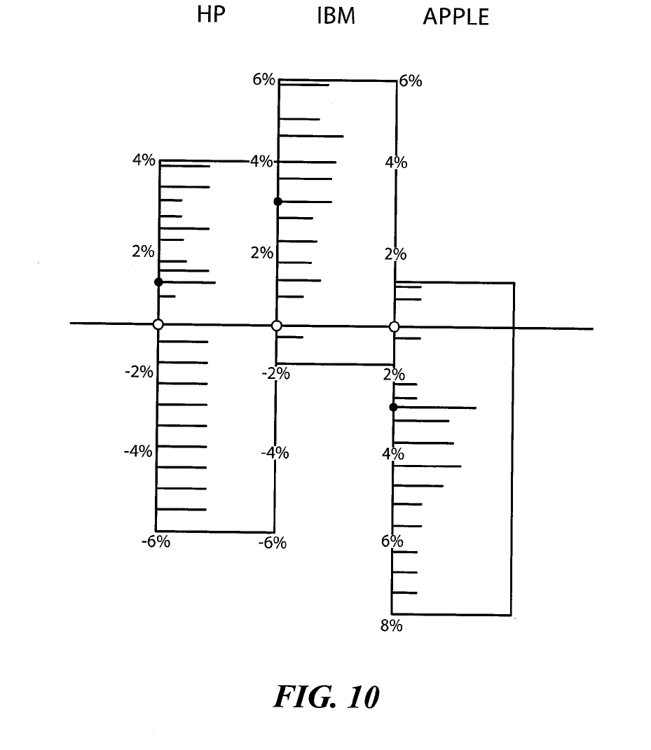

FIG. 10 is a further application of these teachings that enable an observer to examine the price behavior of several entities. In order to make the comparison particularly meaningful, the data can be shown in terms of percent changes, with

0=no change from previous price;

+=increase from previous price; and

−=decrease from previous price.

In this illustrative example, the figure shows that HP has a 4 percent gain and a 6 percent decline respectively from the previous close. Similarly, IBM had a 6 percent gain and a 2 percent decline from the previous close, while Apple had a 1 percent gain and an 8 percent decline from the previous close. The number of entities that can be so depicted is, of course, unlimited, and more can be shown in a similar manner.

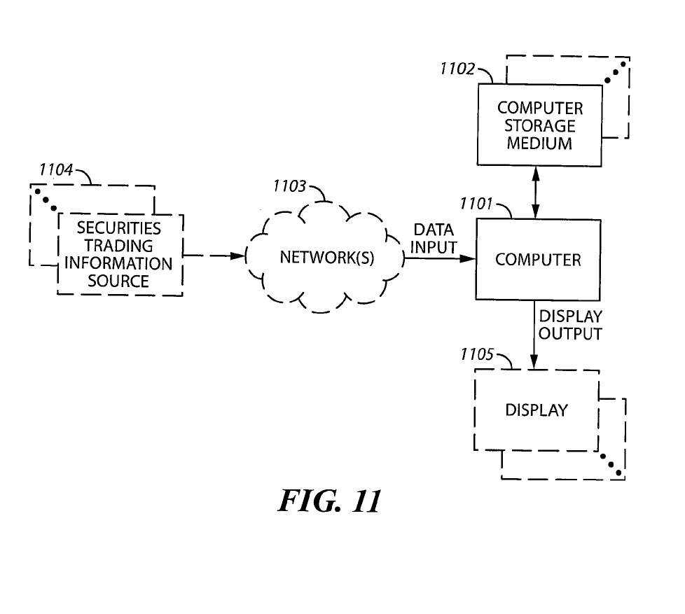

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 11, an illustrative approach to such a platform will now be provided.

In this illustrative example, a computer 1101 having a data input and a display output can be configured (via, for example, corresponding programming as will be well understood by those skilled in the art) to carry out one or more of the steps, actions, and functionalities as are set forth herein. By one approach, this can be done by providing a computer storage medium 1102 that operably couples to the computer 1101 and that serves to store a series of computer-executable instructions that are configured, for example, to carry out the above-described process.

This can specifically comprise, for example, receiving trading information for securities that are traded in a market (as may be provided via one or more networks and as may be sourced by one or more corresponding securities trading information sources 1104 of choice), processing that information to determine the above-described items of corresponding processed information, and displaying that processed information as a chart via, for example, one or more displays 1105 as couple to the computer 1101 via the aforementioned display output. (As used herein, it will be understood that a “display” can comprise an active display such as a computer display screen or a television screen or can comprise a static display modality such as a printed document.) Those skilled in the art will appreciate that applying these teachings to put the market's relevant data (high/low price, closing price, last trading price, and volume) on one vertical axis in a comparative format enables traders to quickly and easily analyze that markets momentum in one concise graphic display (such as the display on a cellular telephone, personal digital assistant, or the like) and/or that does not require much space on a computer screen that is being shared with other items of information that are of interest to a given viewer.

Those skilled in the art will recognize and understand that such an apparatus may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
a computer storage medium having stored therein a series of computer-executable instructions configured to:
receive trading information for securities that are traded in a market;
process the information to determine, for a given one of the securities:
a close price for a current trading period;
a close price for a previous trading period;
a last trading price for the current trading period;
a plurality of trading prices and corresponding trading volumes during the current trading period;
a plurality of trading prices and corresponding trading volumes during the previous trading period;
to provide corresponding processed information; and
display the processed information as a chart, wherein:
the chart has a first area that represents the previous trading period;
the chart has a second area that is positioned adjacent the first area that represents the current trading period;
a vertical axis separates the first area from the second area and identifies trading prices for both the current trading period and the previous trading period;
a plurality of horizontal bars in the first area have a position with respect to the vertical axis to indicate a particular trading price and a length within the first area that indicates the corresponding trading volume at that trading price;
a plurality of horizontal bars in the second area have a position with respect to the vertical axis to indicate a particular trading price and a length within the second area to indicate the corresponding trading volume at that trading price;
and wherein certain, but not all, of the items of processed information are differently highlighted with a unique visual symbol.

2. The apparatus of claim 1 wherein the first area of the chart is bounded by a highest price and a lowest price for the previous trading period.

3. The apparatus of claim 2 wherein the second area of the chart is bounded by a highest price and a lowest price for the current trading period.

4. The apparatus of claim 1 wherein the current trading period comprises a not-yet-completed trading period.

5. The apparatus of claim 4 wherein the close price for the current trading period comprises a most current price for the current trading period.

6. The apparatus of claim 1 wherein the series of computer-executable instructions are further configured to:
receive the trading information on an on-going basis during the current trading period.

7. The apparatus of claim 6 wherein the series of computer-executable instructions are further configured to:
display the processed information as a chart on an on-going updated basis during the current trading period.

8. The apparatus of claim 1 wherein the previous trading period comprises an earlier part of a trading period that also includes the current trading period.

9. The apparatus of claim 1 wherein the unique visual signal comprises a color that is highly contrastive to other colors that comprise the chart.

10. The apparatus of claim 1 wherein the unique visual signal comprises an animated element that contrasts with static elements as comprise the chart.

11. The apparatus of claim 1 wherein the unique visual signal comprises a contrastive graphics element.

12. An apparatus comprising:
a computer having a data input and a display output, the computer being configured to:
receive, via the data input, trading information for securities that are traded in a market;
process the information to determine, for a given one of the securities:
a close price for a current trading period;
a close price for a previous trading period;
a last trading price for the current trading period;
a plurality of trading prices and corresponding trading volumes during the current trading period;
a plurality of trading prices and corresponding trading volumes during the previous trading period;
to provide corresponding processed information; and
output, via the display output, the processed information as a chart, wherein:
the chart has a first area that represents the previous trading period;
the chart has a second area that is positioned adjacent the first area that represents the current trading period;
a vertical axis that separates the first area from the second area and which identifies trading prices for both the current trading period and the previous trading period;
a plurality of horizontal bars in the first area have a position with respect to the vertical axis that indicates a particular trading price and a length within the first area that indicates the corresponding trading volume at that trading price;
a plurality of horizontal bars in the second area have a position with respect to the vertical axis that indicates a particular trading price and a length within the second area that indicates the corresponding trading volume at that trading price;
and wherein a relative minority of the items of processed information are additionally highlighted with a unique visual symbol.

13. The apparatus of claim 12 wherein the first area of the chart is bounded by a highest price and a lowest price for the previous trading period.

14. The apparatus of claim 13 wherein the second area of the chart is bounded by a highest price and a lowest price for the current trading period.

15. The apparatus of claim 12 wherein the current trading period comprises a not-yet-completed trading period.

16. The apparatus of claim 15 wherein the close price for the current trading period comprises a most current price for the current trading period.

17. The apparatus of claim 12 wherein the unique visual signal comprises a color that is highly contrastive to other colors that comprise the chart.

18. The apparatus of claim 12 wherein the unique visual signal comprises an animated element that contrasts with static elements as comprise the chart.

19. The apparatus of claim 12 wherein the unique visual signal comprises a contrastive graphics element.
